(19) United States
(12) Patent Application Publication
(10) Pub. No.: US 2017/0262051 A1
(43) Pub. Date: Sep. 14, 2017

(54) METHOD FOR REFINING CONTROL BY COMBINING EYE TRACKING AND VOICE RECOGNITION

(71) Applicant: Facebook, Inc., Menlo Park, CA (US)

(72) Inventors: Martin Henrik Tall, Frederiksberg (DK); Jonas Priesum, Copenhagen (DK); Javier San Agustin, Copenhagen (DK)

(73) Assignee: The Eye Tribe, Copenhagen (DK)

(21) Appl. No.: 15/066,387

(22) Filed: Mar. 10, 2016

Related U.S. Application Data
(60) Provisional application No. 62/135,904, filed on Mar. 20, 2015.

(51) Int. Cl. G06F 3/01; G06F 3/16

(52) U.S. Cl. CPC G06F 3/013; G06F 3/167; G10L 15/063

(57) ABSTRACT

The invention is a method for combining eye tracking and voice-recognition control technologies to increase the speed and/or accuracy of locating and selecting objects displayed on a display screen for subsequent control and operations.

### TECHNICAL FIELD

The present invention relates to a system control using eye tracking and voice recognition

### BACKGROUND OF THE INVENTION

Computing devices, such as personal computers, smartphones, tablets, and others make use of graphical user interfaces (GUIs) to facilitate control by their users. Objects which may include images, words, and alphanumeric characters can be displayed on screens; and users employ cursor-control devices (e.g. mouse or touch pad) and switches to indicate choice and selection of interactive screen elements. In other cases, rather than cursor and switch, systems may use a touch-sensitive screen whereby a user identifies and selects something by touching its screen location with a finger or stylus. In this way, for example, one could select a control icon, such as “print,” or select a hyperlink. One could also select a sequence of alphanumeric characters or words for text editing and/or copy-and-paste interactions. Cursor control and touch-control panels are designed such that users physically manipulate a control device to locate and select screen items. There are alternative means for such control, however, that do not involve physically moving or touching a control subsystem. One such alternative makes use of eye tracking where a user's gaze at a screen can be employed to identify a screen area of interest and a screen item for interactive selection. Another alternative makes use of voice recognition and associates recognized words with related items displayed on a screen. Neither eye tracking nor voice recognition control, on their own, are as precise with regard to locating and selecting screen objects as, say, cursor control or touch control. In the case of eye tracking, one is often limited in resolution to a screen area rather than a point or small cluster of points. If there is more than one screen object within or near that screen area, then selection may be ambiguous. Similarly, with a screen full of text and object choices, a voice recognition subsystem could also suffer ambiguity when trying to resolve a recognized word with a singularly related screen object or word. Thus, as a result, such control methodologies may employ zooming so as to limit the number of screen objects and increase the distance between them, as in eye tracking control; or require iterative spoken commands in order to increase the probability of correct control or selection interpretation.

### BRIEF SUMMARY OF THE INVENTION

By combining eye tracking and voice recognition controls one can effectively increase the accuracy of location and selection and thereby reduce iterative zooming or spoken commands that are currently required when using one or the other control technology.

The method herein disclosed and claimed enables independently implemented eye tracking and voice recognition controls to co-operate so as to make overall control faster and/or more accurate.

The method herein disclosed and claimed could be employed in an integrated control system that combines eye tracking with voice recognition control.

The method herein disclosed and claimed is applicable to locating and selecting screen objects that may result from booting up a system in preparation for running an application, or interacting with a server-based HTML page aggregate using a client user system (e.g. interacting with a website via the Internet). In essence, this method in conjunction with eye tracking and voice recognition control subsystems would provide enhanced control over the interaction of screen-displayed objects irrespective of the underlying platform specifics.

The method herein disclosed and claimed uses attributes of eye tracking to reduce the ambiguities of voice-recognition control; and uses voice recognition to reduce the ambiguities of eye tracking control. The result is control synergy; that is, control speed and accuracy that exceeds that of eye tracking or voice recognition control on each's own.

### BRIEF DESCRIPTIONS OF THE DRAWINGS

FIG. 1 depicts a display screen displaying non-text and textual objects. The screen, for example, could be any system display and control screen, such as a computer monitor, smartphone screen, tablet screen, or the like.

FIG. 2 depicts the screen of FIG. 1 where eye tracking control determines that the user's gaze is essentially on a non-textual object.

FIG. 3 depicts the screen of FIG. 1 where eye tracking control determines that the user's gaze is essentially on a screen area comprising text objects.

FIG. 4 depicts an exemplary flow chart illustrating how combining eye tracking and voice recognition would increase the confidence level of determining a location and selection, and, therefore, the accuracy.

FIG. 5 depicts an exemplary flow chart illustrating how combining eye tracking and voice recognition would increase the probability level of determining a location and selection, and, therefore, the accuracy.

FIG. 6 depicts an exemplary flow chart illustrating how combining eye tracking and voice recognition would increase the probability level of determining the selected word in a group of words by associating the interpreted word with its occurrence in a smaller screen area determined as the user's gaze screen area.

### DETAILED DESCRIPTION OF THE INVENTION

As interactive computing systems of all kinds have evolved, GUIs have become the primary interaction mechanism between systems and users. With displayed objects on a screen, which could be images, alphanumeric characters, text, icons, and the like, the user makes use of a portion of the GUI that enables the user to locate and select a screen object. The two most common GUI subsystems employ cursor control devices (e.g. mouse or touch pad) and selection switches to locate and select screen objects. The screen object could be a control icon, like a print button, so locating and selecting it may cause a displayed document file to be printed. If the screen object is a letter, word, or highlighted text portion, the selection would make it available for editing, deletion, copy-and-paste, or similar operations. Today many devices use a touch-panel screen which enables a finger or stylus touch to locate and/or select a screen object. In both cases, the control relies on the user to physically engage with a control device in order to locate and select a screen object.

With cursor control, one is usually able to precisely locate and select a screen object. Sometimes one has to enlarge a portion of the screen to make objects larger and move them farther apart from one another in order to precisely locate and select an intended screen object. This zooming function is more typical of finger-touch controls where a finger touch on an area with several small screen objects is imprecise until zooming is applied.

A GUI could also serve to enable location and selection of screen objects without requiring physical engagement. For example, a GUI that makes use of eye tracking control would determine where on a screen the user is gazing (e.g. location) and use some method for selection control (e.g. gaze dwell time). This would be analogous to using a mouse to move a cursor over a screen object and then pressing a button to signify selection intent.

Voice-recognition-based control could also serve as a control technology where physical engagement would not be required. A screen of objects would have a vocabulary of spoken words associated with the objects, and when a user says a word or phrase, the control system recognizes the word and associates it with a particular screen object. So, for example, a screen with an object that is a circle with a letter A in its center could be located and selected by a user who says “circle A,” which may cause the GUI system to highlight it, and then saying “select,” which would cause the GUI system to select the object and perhaps remove the highlighting. Clearly, if there were many objects on a screen, some having the same description, saying “circle” where there are five circles of various size and color would be ambiguous. The system could prompt the user for further delineation in order to have a higher confidence level or higher probability estimation.

Thus, the tradeoff in using eye tracking or voice-recognition control is eliminating the need for physical engagement with a pointing/selecting device or the screen, but accepting less precise location and selection resolution. Often, as a result of the lower resolution, there may be more steps performed before the system can determine the location and selection of an object with a probability commensurate with more resolute controls, such as cursor, touch pad, or touch screen.

Typically, a type-selecting cursor is smaller than an alphanumeric character standing alone or immersed in a word. So, if one is fixing a typographical error, one can select a single letter and delete or change it. Using touch control, the area of finger or stylus touch is typically larger than a cursor pointer. It would be difficult to select a letter immersed in a word for similar typographical error correction. One may have to make several pointing attempts to select the correct letter, or expand (i.e. zoom) the word to larger proportions so that the touch point can be resolved to the single, intended letter target.

Regardless of which GUI location and selection technology one uses, font sizes and non-textual object dimensions will affect the control resolution, but in general, technologies that do not require physical engagement cannot accommodate dense text having small characters and non-text objects having small dimensions without iterative zooming steps.

The method herein disclosed and claimed makes use of eye tracking and voice-recognition control technologies in conjunction to, in effect, improve the accuracy of locating and selecting screen objects using either control technology on its own. The method applies to any system having displayed objects whereby users interact with said system by locating and selecting screen objects and directing the system to carry out some operation or operations on one or a plurality of screen objects. Such systems can comprise combinations of hardware, firmware and software that, in concert, support displaying, locating, selecting and operating on displayed objects. The method may comprise interacting with system hardware and/or software as part of an integrated control subsystem incorporating eye tracking and voice-recognitions controls; or as part of a system in which separate eye tracking and voice-recognition control subsystems can interact. The method invention herein disclosed and claimed should therefore not be limited in scope to any particular system architecture or parsing of hardware and software.

Eye tracking technology or subsystem refers to any such technology or subsystem, regardless of architecture or implementation, which is capable of determining approximately where a user's eye or eyes are gazing at some area of a display screen. The eye tracking technology or subsystem may also be capable of determining that a user has selected one or more objects in the gazed area so located. An object could be an icon or link that initiates an operation if so selected.

Voice-recognition technology or subsystem refers to any such technology or subsystem, regardless of architecture or implementation, which is capable of recognizing a user's spoken word or phrase of words and associating that recognized word or phrase with a displayed object and/or an operational command.

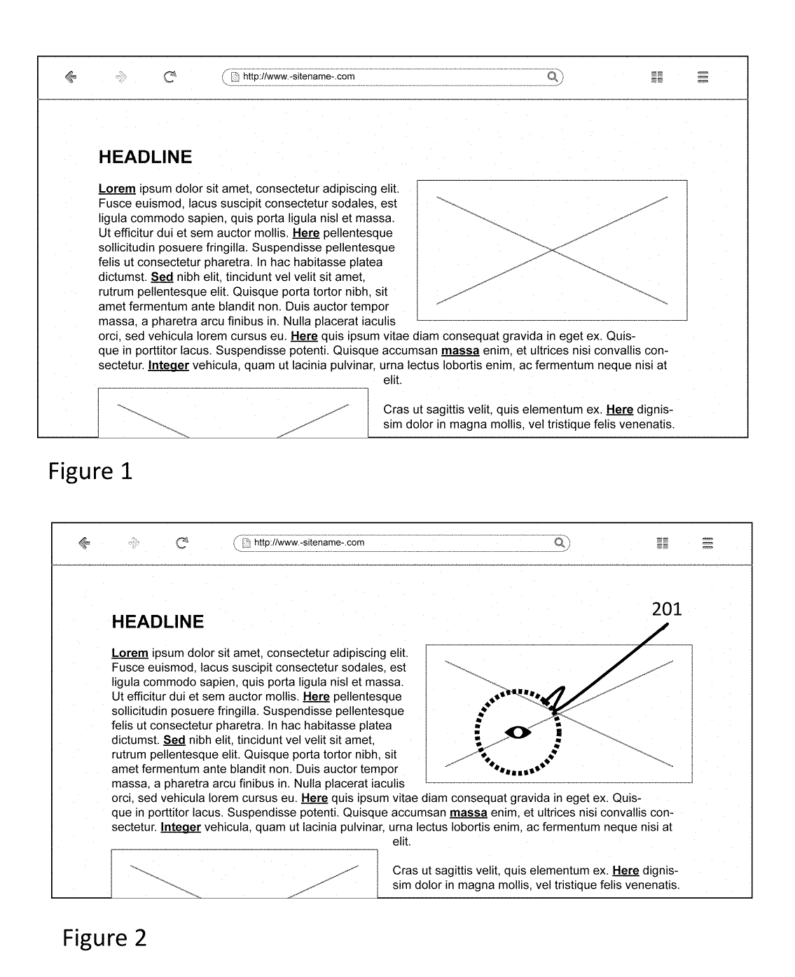

FIG. 1 depicts a display of objects on a screen. Objects consist of text objects, such as alphanumeric characters, words, sentences and paragraphs; and non-text objects which comprise images, line art, icons, and the like. This drawing is exemplary and should not be read as limiting the layout and content of objects on a screen.

With eye tracking control technology one can determine an area where a user's eye or eyes are gazing at the screen of FIG. 1. For example, in FIG. 2, an eye tracking control subsystem has determined that a user's eye is gazing at a portion of a non-text object and the gazed area is defined by the area circled by 201.

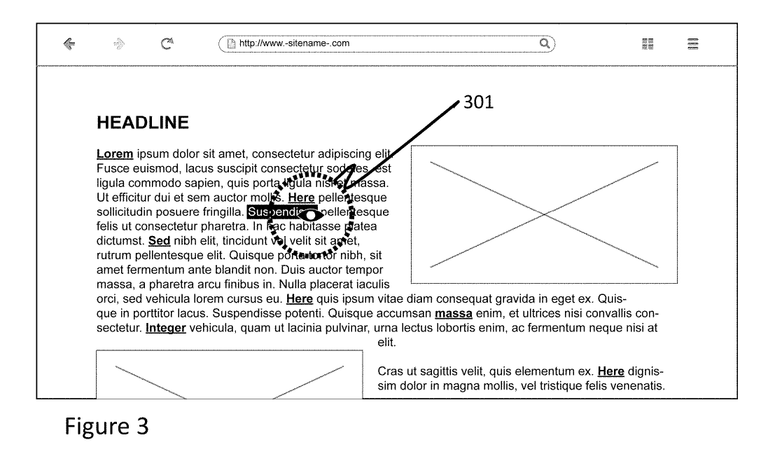

FIG. 3 depicts the screen of FIG. 1 where an eye tracking control subsystem has determined that a user's eye is gazing at a portion of text objects, the area of which is circled by 301.

In FIG. 2, if the non-text object were smaller than 201, and more than one such object were located in area 201, the eye tracking subsystem could not, at that time, resolve which object in area 201 is a user's object of interest. By engaging in a subsequent step, the screen objects could be enlarged such that only one object would be located in area 201. But the subsequent step adds time for the sake of accuracy. It may also be the case that a first zooming attempt results in two or more objects still within area 201. Hence, a second zoom operation may have to be done in order to determine the object of interest. Here, again, more time is used.

In FIG. 3, the gazed area, 301, covers a plurality of alphanumeric characters and words. Here, again, the eye tracking control subsystem would be unable to determine specifically which character or word is the object of interest. Again, iterative zoom operations may have to be done in order to resolve which letter or word is the object of interest. As with the non-text object case, each time a zoom operation is applied, more time is required.

Using a voice-recognition technology in association with FIG. 1, the entire visible screen and any of its objects could be a user's object of choice. For example, if the user said “delete word ‘here’”, the voice-recognition subsystem would first have to recognize the word “here,” then associate it with any instances of it among the screen objects. As shown in FIG. 1, there are three instances of the word “here.” Thus, the voice-recognition subsystem would be unable to resolve the command to a singular object choice. It may have to engage in a repetitive sequence of highlighting each instance of “here” in turn until the user says “yes,” for example. This would take more time.

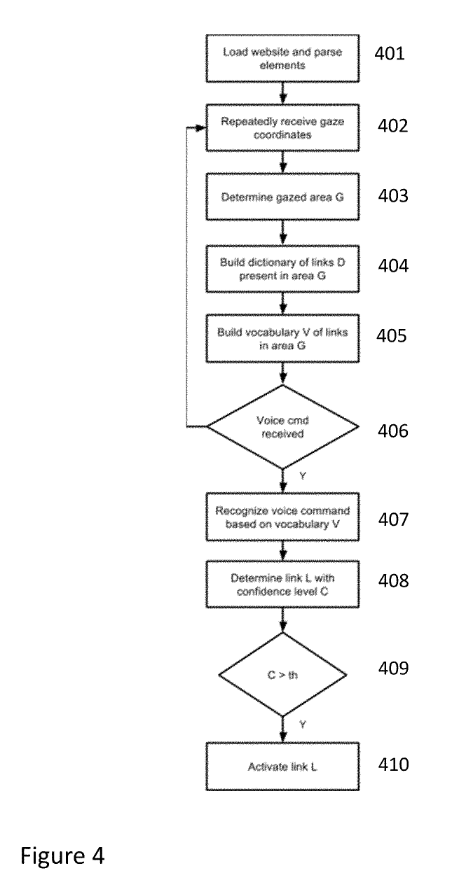

In one embodiment of the invention herein disclosed and claimed, FIG. 4 shows an exemplary task flow. The flow shown in FIG. 4 should not be read as limiting. The flow begins 401 where a system loads and parses the elements that will comprise the screen objects. Although not shown in the flow chart, this operation may be done repeatedly. In 402, the eye tracking subsystem computes repeated screen gaze coordinates and passes them to the system. From 402, a gazed area, G, is determined (403). In 404 and 405, once area G is determined, the system builds a dictionary of links, D, and vocabulary, V, for those found links in area G. Depending on the capabilities of the computing device and/or the voice recognition subsystem, vocabulary V may be updated for every gaze coordinate, for every fixation, every N gaze coordinates, every T milliseconds, and so on. Steps 402 through 405 continue to refresh until a voice command is received (406). The system then recognizes the voice command based on vocabulary, V (407) and determines link L along with a confidence level of accuracy, C (408). With voice recognition, extraneous sounds coupled with a voice command, can also introduce audio artifacts that may reduce recognition accuracy. In order to avoid incorrect selections due to extraneous sounds, the confidence level C may be compared to a threshold value, th, and if it is greater (409), then the system activates link L (410), otherwise it returns to operation (402). The threshold th may take a fixed value, or it may be computed on a per-case basis depending on different factors, for example, noise in the gaze coordinates, on-screen accuracy reported by the eye tracking system, confidence level in the gaze coordinates, location of the link L on the screen, or any combination of these. Here is a case where eye tracking technology is used to reduce the whole screen of possible objects to just those within the gazed area, G. Rather than having to iterate with repeated zoom steps, by using the eye tracking gazed area G as a delineator, the system can activate the link, L, with sufficient level of confidence using fewer steps and in less time.

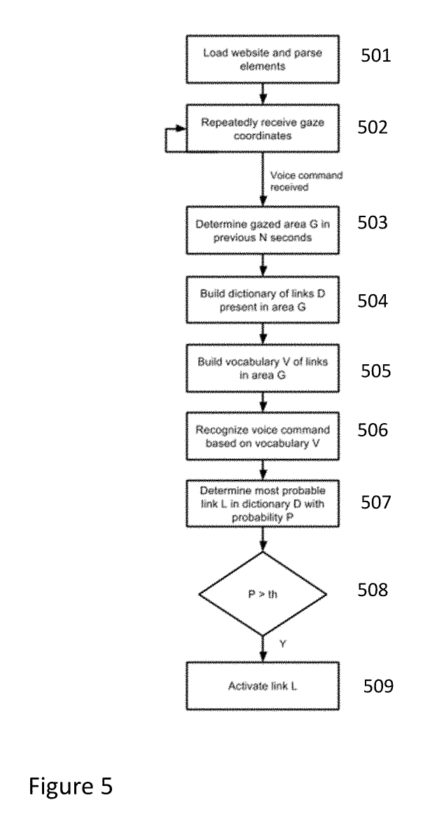

In another embodiment, FIG. 5 shows an exemplary task flow. The flow in FIG. 5 should not be read as limiting. The flow begins with 501 where a system loads and parses the elements that will comprise the screen objects. Although not shown in the flow chart, this operation may be done repeatedly. The eye control subsystem repeatedly refreshes the gazed area coordinates and feeds that data to the system (502). When a voice command is received (503), a gazed area G is determined by the eye tracking coordinates received during a time window that may extend from the time the command is received to some predetermined number of seconds before that (504). A dictionary of links, D, present in area G is built (505) and a vocabulary, V, of links in the area G is built (506). The voice command is recognized based on V (507) with probability P. In case multiple links are recognized, the accuracy probability P for each link may be computed (508) based on different factors, for example, the confidence level of the voice recognition C, the distance from the gaze point or a fixation to the link, the duration of said fixation, time elapsed between link being gazed upon and emission of the voice command, and the like; and the link with highest probability P may be selected. If P is larger than a threshold value (509), th, then the link, L, is activated (510), otherwise the system returns to operation (502) and waits for a new voice command. The threshold value th may take a fixed value, or it may be computed on a per-case basis as explained above for operation (409). Note that in both FIGS. 4 and 5 a link is activated. In fact, these operations are not limited to links, but rather, could be applied to any interactive screen object.

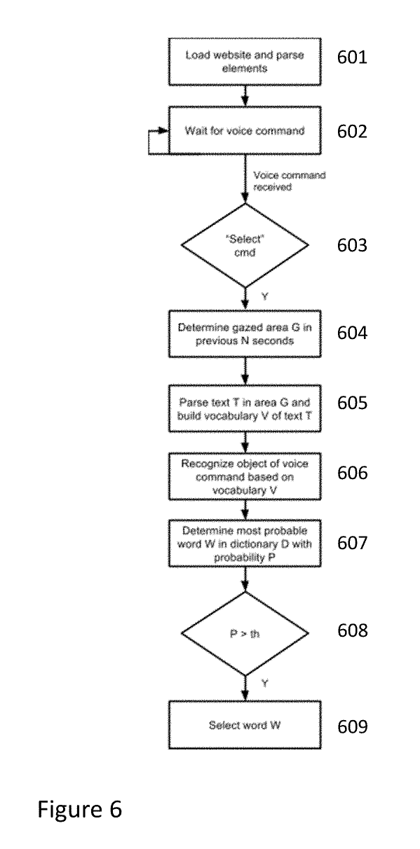

In another embodiment, FIG. 6 shows an exemplary task flow. The flow in FIG. 6 should not be read as limiting. The flow begins with the system loading and parsing the elements that will comprise the screen objects. Although not shown in the flow chart, this operation may be done repeatedly. Then, the system awaits a voice command. Here, for example, the command is “select” (603). A gazed area, G, is determined (604) by using the eye tracking coordinates received during a time window that may extend from the time the command is received to some predetermined number of seconds before that. Here, the gazed area is as in FIG. 3 over text objects. So, the text is parsed, T, in area G and a vocabulary, V, is built (605). Based on vocabulary, V, the text object of the voice command is recognized (606). A word, W, is evaluated as to probability, P, (607) and compared to a threshold value (608), th. If P exceeds th, word W is selected (609). Probability P and threshold value th may be computed as explained previously.

The flows shown in FIGS. 4, 5 and 6 are exemplary. In each example, the entire screen of objects is reduced to those objects within a gazed area increasing the confidence or probability level without resorting to zooming operations. It is of course possible that a gazed area will still continue to have some object of interest ambiguity, but the likelihood is far lower than with using only voice-recognition control. Often the spoken word in combination with gazed area is sufficient to resolve the object of interest without any zooming operations. Clearly, the combination of eye tracking and voice-recognition technologies will resolve the object of interest faster than either eye tracking or voice-recognition controls applied exclusively.

What is claimed is:

1. A method comprising:
determining an area on a display screen at which a user is gazing;
recognizing a spoken word or plurality of spoken words;
associating said spoken word or plurality of spoken words with objects displayed on said display screen;
limiting said objects displayed on said display screen to said area on said screen at which a user is gazing;
associating said objects displayed on said display screen in said area on a screen at which said user is gazing with said spoken word or plurality of spoken words.

2. A method as in claim 1 further comprising:
determining a level of confidence in said associating said objects displayed on said display screen in said area on a screen at which said user is gazing with said spoken word or plurality of spoken words;
comparing said level of confidence with a predetermined level of confidence value and if greater than said predetermined level of confidence value, accepting the association of said spoken word or plurality of spoken words with said objects displayed on said display screen in said area on a screen which said user is gazing.

3. A method as in claim 1 further comprising:
determining said level of confidence value based on the accuracy of the gaze coordinates, the noise of the gaze coordinates, the confidence level in the gaze coordinates, the location of the objects on the screen, or any combination thereof.

4. A method as in claim 1 further comprising:
determining a level of probability in said associating said objects displayed on said display screen in said area on a screen at which said user is gazing with recognizing said spoken word or plurality of spoken words;
comparing said level of probability with a predetermined level of probability value and if greater than said predetermined level of probability value, accepting the association of said spoken word or plurality of spoken words with said objects displayed on said display screen in said area on a screen at which said user is gazing.

5. A method as in claim 4 further comprising:
determining said level of probability based on the confidence level of the voice recognition, the distance from the gaze fixation to each object, the duration of the gaze fixation, the time elapsed between the gaze fixation and the emission of the voice command, or any combination thereof.

6. A method comprising:
determining the objects present in an area on a display screen at which said user is gazing,
building a vocabulary of a voice recognition engine based on said objects,
recognizing a spoken word or plurality of spoken words using said vocabulary;
associating said objects present in the gazed area with said spoken word or plurality of spoken words.

7. A method as in claim 6 further comprising
updating said vocabulary of said voice recognition engine on every fixation of said user.
